(19) United States
(12) Patent Application Publication
(10) Pub. No.: US 2019/0124686 A1
(43) Pub. Date: Apr. 25, 2019

(54) LOW-POWER WIDE-AREA NETWORK SERVER AND TERMINAL, AND A METHOD OF AVOIDING UPLINK TRANSMISSION COLLISION

(71) Applicant: Institute For Information Industry, Taipei (TW)

(72) Inventors: Chih-Yuan LO, Tainan City (TW); Shu-Han LIAO, New Taipei City (TW); Yang-Han LEE, Taoyuan City (TW)

(21) Appl. No.: 15/817,150

(22) Filed: Nov. 17, 2017

(30) Foreign Application Priority Data
Oct. 25, 2017 (TW) 106136715

(51) Int. Cl. H04W 74/04; H04W 74/00

(52) U.S. Cl. CPC H04W 74/04; H04L 12/2854; H04W 74/006

(57) ABSTRACT

Embodiments relate to a low-power wide-area network (LPWAN) server, an LPWAN terminal and a method of avoiding uplink transmission collision. The LPWAN server stores information related to a plurality of LPWAN terminals, and defines a delay parameter for each of the plurality of LPWAN terminals according to the information. The LPWAN server also transmits the plurality of delay parameters to the plurality of LPWAN terminals via an LPWAN gateway, and each of the plurality of the LPWAN terminals delays its uplink transmission according to the corresponding delay parameter.

### PRIORITY

This application claims priority to Taiwan Patent Application No. 106136715 filed on Oct. 25, 2017, which is hereby incorporated by reference in its entirety.

### FIELD

Embodiments of the present invention relate to a server, a terminal and a method of avoiding uplink transmission collision. More particularly, embodiments of the present invention relate to a low-power wide-area network server, a low-power wide-area network terminal and a method of avoiding uplink transmission collision.

### BACKGROUND

The low-power wide-area network (LPWAN) technology is a network technology for implementing Internet of Things (IOT). Conceptually, the low-power wide-area network is a communication network designed for remote distance, low power, low bandwidth and a large number of terminals, and it generally may comprise three levels, namely an upper server level, a middle gateway level and a lower terminal level. The server level and the terminal level may communicate via the gateway level functioning as a bridge to transmit data message and/or control message therebetween.

Since the low-power wide-area network can contain a large number of terminals, the terminals have to contend for networked resources if the resources are limited. Therefore, collision is very likely to occur during the uplink transmission of these terminals. Accordingly, an urgent need exists in the art to avoid uplink transmission collision of the LPWAN system.

### SUMMARY

The disclosure includes a low-power wide-area network (LPWAN) server that addresses the aforesaid problem. The LPWAN server may comprise a storage, a processor electrically connected with the storage, and a transceiver electrically connected with the processor. The storage may be configured to store information related to a plurality of LPWAN terminals. The processor is configured to define a delay parameter for each of the plurality of LPWAN terminals according to the information. The transceiver may be configured to transmit the plurality of delay parameters to the plurality of LPWAN terminals via an LPWAN gateway so that each of the plurality of LPWAN terminals delays its uplink transmission according to the corresponding delay parameter.

The disclosure also includes a method of avoiding uplink transmission collision that addresses the aforesaid problem. The method may comprise the following steps of:

storing, by an LPWAN server, information related to a plurality of LPWAN terminals;

defining, by the LPWAN server, a delay parameter for each of the plurality of LPWAN terminals according to the information; and

transmitting, by the LPWAN server, the plurality of delay parameters to the plurality of LPWAN terminals via an LPWAN gateway so that each of the plurality of LPWAN terminals delays its uplink transmission according to the corresponding delay parameter.

The disclosure further includes a low-power wide-area network (LPWAN) terminal that addresses the aforesaid problem. The LPWAN terminal may comprise a transceiver and a processor electrically connected with the transceiver. The transceiver may be configured to receive a delay parameter transmitted by an LPWAN server via an LPWAN gateway. The processor may be configured to instruct the transceiver to delay an uplink transmission of the LPWAN terminal according to the delay parameter.

According to the above descriptions, in the embodiments of the present invention, an LPWAN server may properly define a delay parameter for each of a plurality of LPWAN terminals according to various information related to the plurality of LPWAN terminals (e.g., a received signal strength indicator related to each of the plurality of LPWAN terminals, an application type of each of the plurality of LPWAN terminals, a number of re-transmissions of each of the plurality of LPWAN terminals, a density of the plurality of LPWAN terminals, and/or a transmission type of each of the plurality of LPWAN terminals), and each of the LPWAN terminals can delay its uplink transmission according to the corresponding delay parameter. Accordingly, time points at which the plurality of LPWAN terminals initiate the uplink transmission thereof can be staggered so as to avoid collision of all or a part of uplink transmissions of the plurality of LPWAN terminals (no matter on the LPWAN gateway or on the LPWAN server).

This summary overall describes the core concept of the present invention and covers the problem to be solved, the means to solve the problem and the effect of the present invention to provide a basic understanding of the present invention by a person having ordinary skill in the art. However, it shall be appreciated that, this summary is not intended to encompass all embodiments of the present invention but is provided only to present the core concept of the present invention in a simple form and as an introduction to the following detailed description.

### BRIEF DESCRIPTION OF THE DRAWINGS

FIG. 1 illustrates a low-power wide-area network (LPWAN) system in one or more embodiments of the present invention;

FIG. 2 illustrates an operating mode of the LPWAN system shown in FIG. 1 in one or more embodiments of the present invention;

FIG. 3 illustrates another operating mode of the LPWAN system shown in FIG. 1 in one or more embodiments of the present invention; and

FIG. 4 illustrates a method of avoiding uplink transmission collision in one or more embodiments of the present invention.

### DETAILED DESCRIPTION

Example embodiments of the present invention described below are not intended to limit the present invention to any environment, applications, structures, processes or steps described in these example embodiments. In the attached drawings, elements unrelated to the present invention are omitted from depiction; and dimensions of elements and proportional relationships among individual elements in the attached drawings are only exemplary examples but not intended to limit the present invention. Unless stated particularly, same (or similar) element symbols may correspond to same (or similar) elements in the following description.

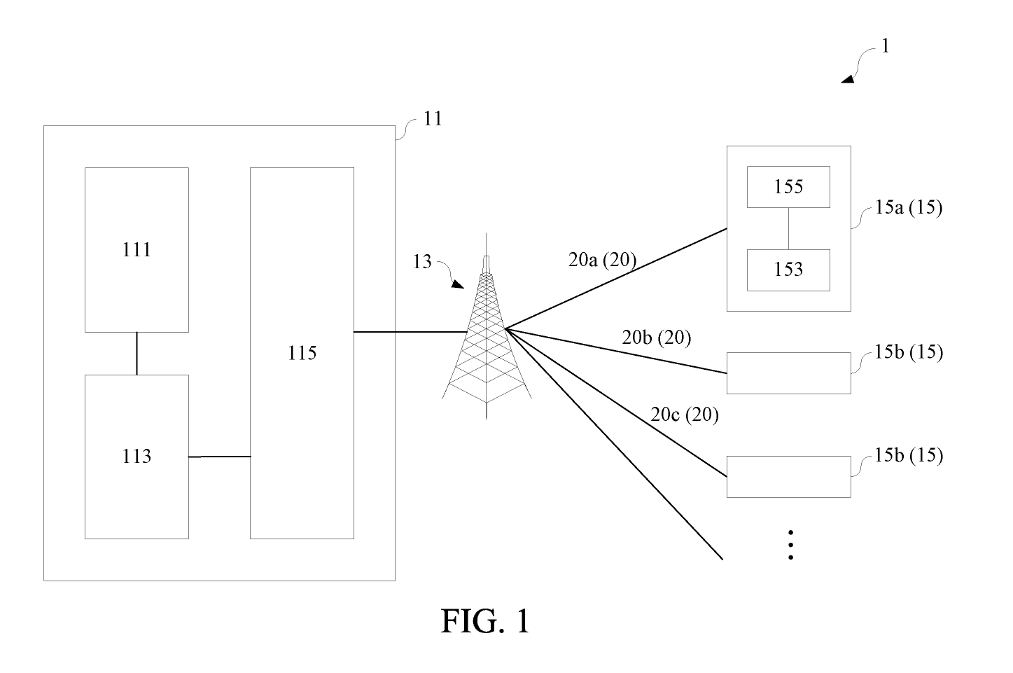

FIG. 1 illustrates a low-power wide-area network (LPWAN) system in one or more embodiments of the present invention. However, contents shown in FIG. 1 are only for purpose of illustrating embodiments of the present invention instead of limiting the present invention.

Referring to FIG. 1, an LPWAN system 1 may be a network communication system constructed under various low-power wide-area networks designed for remote distance, low power, low bandwidth and a large number of terminals. The LPWAN system 1 may support functions of: containing 10 bytes to 1000 bytes of data in the case where the speed of an uplink is up to 200 Kbps; and performing long-distance transmission from 2 kilometers to 1000 kilometers, e.g., transmitting messages of 30 to 50 kilometers in a rural area and messages of 3 to 10 kilometers in an urban area, and transmitting messages of up to 1000 kilometers in direct point-to-point transmission. The LPWAN system 1 may be a communication architecture using an authorized frequency band, which is for example but not limited to Narrow Band-IoT (NB-IoT), EC-GSM-IoT, LTE Cat-M or the like. Alternatively, the LPWAN system 1 may be a communication architecture using an unauthorized frequency band, which is for example but not limited to LoRaWAN, Sigfox, Weightless, HaLow, Random Phase Multiple Access (RPMA) or the like.

The LPWAN system 1 may comprise one or more LPWAN servers 11, one or more LPWAN gateways 13 and a plurality of LPWAN terminals 15. Each of the LPWAN servers 11 may comprise a storage 111, a processor 113 and a transceiver 115, wherein the processor 113 may be electrically connected to the storage 111 and the transceiver 115 respectively. Each of the LPWAN terminals 15 may comprise a processor 153 and a transceiver 155, wherein the processor 153 is electrically connected to the transceiver 155.

Each of the processor 113 and the processor 153 may be one of various microprocessors or microcontrollers capable of signal processing. Each of the microprocessors or microcontrollers is a programmable specific integrated circuit which is capable of operating, storing, outputting/inputting or the like and may receive and process various coded instructions, thereby performing various logic operations and arithmetic operations and outputting corresponding operational results. The processor 113 may be programmed to interpret various instructions so as to process data in the LPWAN server 11 and execute various operational procedures. The processor 153 may be programmed to interpret various instructions so as to process data in the LPWAN terminal 15 and execute various operational procedures.

The storage 111 may comprise primary memories (which are also called main memories or internal memories), and the memories at this level may directly communicate with the processor 113. The processor 113 may read instruction sets stored in the memories, and execute these instruction sets if needed. The storage 111 may further comprise secondary memories (which are also called external memories or auxiliary memories), and the memories at this level connect to the processor through I/O channels of the memories, and use a data buffer to transmit data to the primary memories. The data in the secondary memories does not disappear even in the case without power supply (i.e., is non-volatile). The secondary memories may for example be various types of hard disks, optical disks or the like. The storage 111 may further comprise a third-level storage device, i.e., a storage device that can be inserted into or pulled out from a computer directly, e.g., a mobile disk. In some embodiments, each of the LPWAN terminals 15 may also comprise a storage (not shown) like the storage 111.

Each of the transceiver 115 and the transceiver 155 may be constituted by a transmitter and a receiver, and may comprise for example but not limited to communication elements such as an antenna, an amplifier, a modulator, a demodulator, a detector, an analog-to-digital converter, a digital-to-analog converter or the like. The transceiver 115 may enable the LPWAN server 11 to communicate and exchange data with an external device. The transceiver 155 may enable the LPWAN terminal 15 to communicate and exchange data with an external device. For example, as shown in FIG. 1, the transceiver 115 of the LPWAN server 11 may connect to the LPWAN gateway 13, and the transceiver 155 of the LPWAN terminal 15 may connect to the LPWAN gateway 13 so that the LPWAN server 11 and the LPWAN terminal 15 may communicate with each other via the LPWAN gateway 13.

The LPWAN gateway 13 may be one of various types of IOT gateways, and the LPWAN server 11 and the LPWAN terminal 15 may communicate to transmit data messages and/or control messages with each other via the LPWAN gateway 13 functioning as a bridge.

The connection mentioned with reference to FIG. 1 above may be direct connection (i.e., connection not via other elements with specific functions) or indirect connection (i.e., connection via other elements with specific functions) depending on different demands.

Still referring to FIG. 1, the storage 111 of the LPWAN server 11 may be configured to store information related to a plurality of LPWAN terminals 15, and the processor 113 of the LPWAN server 11 may be configured to define a delay parameter 20 for each of the plurality of LPWAN terminals 15 according to the information. The transceiver 115 of the LPWAN sever 11 may be configured to transmit the plurality of delay parameters to the plurality of LPWAN terminals 15 via the LPWAN gateway 13. For example, the transceiver 115 may transmit delay parameters 20a, 20b and 20c respectively to a plurality of LPWAN terminals 15a, 15b and 15c. The transceiver 155 of each LPWAN terminal 15 may be configured to receive a delay parameter 20, and the processor 153 of each LPWAN terminal 15 may be configured to instruct the transceiver 155 to delay an uplink transmission of the LPWAN terminal 15 according to the delay parameter 20. For example, the LPWAN terminals 15a, 15b and 15c may delay the uplink transmission thereof respectively according to the delay parameters 20a, 20b and 20c. A smaller value of the delay parameter 20 means that the LPWAN terminal 15 will perform the uplink transmission earlier (i.e., with a shorter delay time), and a larger value of the delay parameter 20 means that the LPWAN terminal 15 will perform the uplink transmission later (i.e., with a longer delay time). Therefore, a plurality of uplink transmission time points of the plurality of LPWAN terminals 15 can be staggered by the delay parameters 20 to avoid the occurrence of collision.

The information related to the plurality of LPWAN terminals 15 that is stored by the LPWAN server 11 may comprise various kinds of information which includes for example but not limited to: a received signal strength indicator (RSSI) related to each of the plurality of LPWAN terminals 15, an application type of each of the plurality of LPWAN terminals 15, the number of re-transmissions of each of the plurality of LPWAN terminals 15, a density of the plurality of LPWAN terminals 15, and a transmission type of each of the plurality of LPWAN terminals 15 or the like.

The LPWAN server 11 may obtain a received signal strength indicator, an application type, the number of re-transmissions, a transmission type of each of the plurality of LPWAN terminals 15 and obtain a density of the plurality of LPWAN terminals 15 according to data transmitted by the plurality of LPWAN terminals 15, data transmitted by the LPWAN gateway 13, or terminal data recorded by the LPWAN server 11 itself for the plurality of LPWAN terminals 15 (e.g., registration data, connection data, identification data or the like), and store the information as the information related to the plurality of LPWAN terminals 15.

For example, after receiving data transmitted by a certain LPWAN terminal 15, the LPWAN gateway 13 may analyze the data to calculate a received signal strength indicator of the LPWAN terminal 15 in some embodiments. Then, the LPWAN gateway 13 may carry the received signal strength indicator in data to be transmitted to the LPWAN server 11 so that the LPWAN server 11 can obtain the received signal strength indicator. In some embodiments, the received signal strength indicator may be calculated by the LPWAN terminal 15 instead of the LPWAN gateway 13.

The value of the received signal strength indicator may reflect the distance between the LPWAN terminal 15 and the LPWAN gateway 13, and is inversely proportional to the distance. A larger received signal strength indicator represents a closer distance between the corresponding LPWAN terminal 15 and LPWAN gateway 13, and a smaller received signal strength indicator represents a further distance between the corresponding LPWAN terminal 15 and LPWAN gateway 13. The received signal strength indicator may also be inversely proportional to the delay parameter 20. Therefore, the LPWAN server 11 may define a smaller delay parameter 20 for the LPWAN terminal 15 having a larger received signal strength indicator so that the LPWAN terminal 15 having the larger received signal strength indicator performs the uplink transmission earlier, and the LPWAN server 11 may define a larger delay parameter 20 for the LPWAN terminal 15 having a smaller received signal strength indicator so that the LPWAN terminal 15 having the smaller received signal strength indicator performs the uplink transmission later.

For example, if the distance between the LPWAN terminal 15a and the LPWAN gateway 13 is smaller than the distance between the LPWAN terminal 15b and the LPWAN gateway 13, and the distance between the LPWAN terminal 15b and the LPWAN gateway 13 is smaller than the distance between the LPWAN terminal 15c and the LPWAN gateway 13, then the received signal strength indicator related to the LPWAN terminal 15a may be larger than the received signal strength indicator related to the LPWAN terminal 15b, and the received signal strength indicator related to the LPWAN terminal 15b may be larger than the received signal strength indicator related to the LPWAN terminal 15c. In this case, the delay parameter 20a set by the LPWAN server 11 for the LPWAN terminal 15a may be smaller than the delay parameter 20b set by the LPWAN server 11 for the LPWAN terminal 15b, and the delay parameter 20b may be smaller than the delay parameter 20c set for the LPWAN terminal 15c.

The application type of the LPWAN terminal 15 may be determined based on factors such as characteristics, roles and functions of the LPWAN terminal 15. The application type of the LPWAN terminal 15 may reflect the importance thereof, and the LPWAN server 11 may define a smaller delay parameter 20 for the LPWAN terminal 15 of more importance so that the LPWAN terminal 15 can perform the uplink transmission earlier. On the contrary, the LPWAN server 11 may define a larger delay parameter 20 for the LPWAN terminal 15 of less importance so that the LPWAN terminal 15 can perform the uplink transmission later.

For example, if the importance of the LPWAN terminal 15a is larger than the importance of the LPWAN terminal 15b, and the importance of the LPWAN terminal 15b is larger than the importance of the LPWAN terminal 15c, then the delay parameter 20a set by the LPWAN server 11 for the LPWAN terminal 15a may be smaller than the delay parameter 20b set by the LPWAN server 11 for the LPWAN terminal 15b, and the delay parameter 20b may be smaller than the delay parameter 20c set for the LPWAN terminal 15c.

The number of re-transmissions of the LPWAN terminal 15 may be the number of times that the LPWAN terminal 15 re-transmits data due to failure of uplink transmission. The LPWAN server 11 may define a smaller delay parameter 20 for the LPWAN terminal 15 having a larger number of re-transmissions so that the LPWAN terminal 15 can perform the uplink transmission earlier. On the contrary, the LPWAN server 11 may define a larger delay parameter 20 for the LPWAN terminal 15 having a smaller number of re-transmissions so that the LPWAN terminal 15 can perform the uplink transmission later.

For example, if the number of re-transmissions of the LPWAN terminal 15a is larger than that of the LPWAN terminal 15b, and the number of re-transmissions of the LPWAN terminal 15b is larger than that of the LPWAN terminal 15c, then the delay parameter 20a set by the LPWAN server 11 for the LPWAN terminal 15a may be smaller than the delay parameter 20b set by the LPWAN server 11 for the LPWAN terminal 15b, and the delay parameter 20b may be smaller than the delay parameter 20c set for the LPWAN terminal 15c.

The density of the plurality of LPWAN terminals 15 may be represented as the number of LPWAN terminals 15 within the service coverage of an LPWAN gateway 13. Generally speaking, the larger the number (i.e., the higher the density) of the LPWAN terminals 15 in the service coverage of the LPWAN gateway 13 is, the higher the probability of uplink transmission collision among the LPWAN terminals 15 will be. Therefore, the LPWAN server 11 may define a larger delay parameter 20 for the LPWAN terminal 15 under an environment of a lower density, and the LPWAN server 11 may define a smaller delay parameter 20 for the LPWAN terminal 15 under an environment of a higher density.

The transmission type of the LPWAN terminal 15 may be represented as the transmission type currently adopted by the LPWAN terminal 15 in the case where the LPWAN terminal 15 has multiple transmission types. For example, under technical specifications of LoRa, the transmission type of the LPWAN terminal 15 may comprise three types, namely a type A, a type B and a type C. According to different demands, the LPWAN server 11 may define the delay parameter 20 for the LPWAN terminals 15 of different transmission types.

For example, if the LPWAN terminals 15a, 15b and 15c respectively belong to the type A, the type B and the type C, then in order to reduce power consumption, the delay parameter 20a set by the LPWAN server 11 for the LPWAN terminal 15a may be larger than the delay parameter 20b set by the LPWAN server 11 for the LPWAN terminal 15b, and the delay parameter 20b may be greater than the delay parameter 20c set for the LPWAN terminal 15c. This is because under the technical specifications of LoRa, the power consumption of the terminal belonging to the type C is larger than the power consumption of the terminal belonging to the type B, and the power consumption of the terminal belonging to the type B is larger than the power consumption of the terminal belonging to the type A.

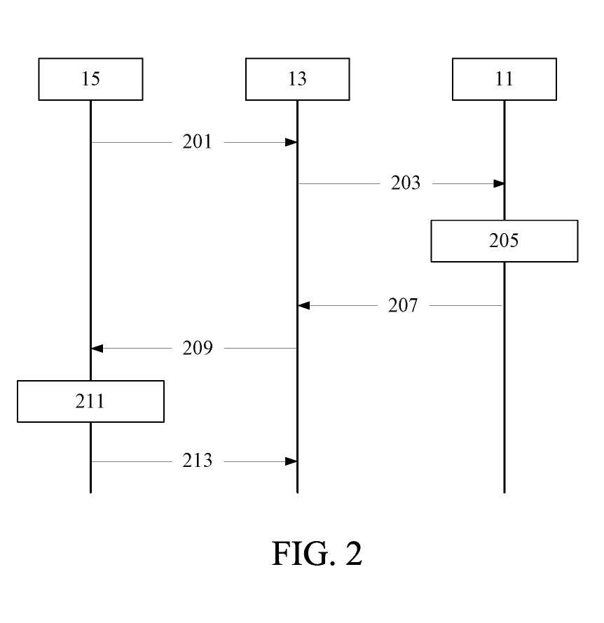

FIG. 2 illustrates an operating mode of the LPWAN system shown in FIG. 1 in one or more embodiments of the present invention. However, contents shown in FIG. 2 are only for purpose of illustrating embodiments of the present invention instead of limiting the present invention.

Referring to FIG. 2, any uplink transmission process may comprise four basic procedures respectively of: transmitting data to the LPWAN gateway 13 by the LPWAN terminal 15 (labeled as 201); transmitting data to the LPWAN server 11 by the LPWAN gateway 13 (labeled as 203); transmitting an acknowledgment (ACK) message to the LPWAN gateway 13 by the LPWAN server 11 after receiving the data (labeled as 207); and transmitting the acknowledgement message (the ACK or NACK message) to the LPWAN terminal 15 by the LPWAN gateway 13 (labeled as 209). Before transmitting the ACK message, the LPWAN server 11 may define a delay parameter 20 for each of the plurality of LPWAN terminals 15 according to information related to the plurality of LPWAN terminals 15 (labeled as 205), and carry the delay parameter 20 in the ACK message.

In FIG. 2, the LPWAN server 11 may define a delay parameter 20 for each of the LPWAN terminals 15 based on the following equation, wherein the delay parameter 20 may be an upper limit reference value of a range of a random delay variable:

$${N}_{max} = {a}_{0} \times AP \times \frac{DD}{RR \times RE} \times TR \qquad ( 1 )$$

where Nₘₐₓ is the delay parameter 20, a₀ is a coefficient randomly generated, AP is an application type indicator (or a data importance indicator) corresponding to the LPWAN terminal 15, DD is a density indicator corresponding to the LPWAN terminal 15, RR is a received signal strength indicator corresponding to the LPWAN terminal 15, RE is a number of re-transmissions indicator corresponding to the LPWAN terminal 15, and TR is a transmission type indicator corresponding to the LPWAN terminal 15.

AP may be a certain value in a set of positive integers (e.g., a set {1, 2, 3}), and each value in the set corresponds to an application type. The higher the value of AP is, the lower the importance of the application type is, and the larger Nₘₐₓ will be. DD may be a positive integer (e.g., 1000), and the higher the value of DD is, the larger Nₘₐₓ will be. RR may be a value represented using a negative dBm, and the higher the value of RR is, the smaller Nₘₐₓ will be. RE may be a positive integer (e.g., 5), and the higher the value of RE is, the smaller Nₘₐₓ will be. TR may be a certain value in a set of positive integers (e.g., a set {1, 2, 3}), and each value in the set corresponds to a transmission type. The higher the value of TR is, the larger Nₘₐₓ will be. In some embodiments, if one(s) of AP, DD, RR, RE and TR is/are not taken into consideration in calculating Nₘₐₓ, then the parameter(s) corresponding to the one(s) in the equation (1) may be set to be 1.

Still referring to FIG. 2, Nₘₐₓ may be an upper limit reference value of a range of a random delay variable. Therefore, after receiving the corresponding delay parameter 20 (i.e., Nₘₐₓ), each of the LPWAN terminals 15 may randomly generate a delay value in the range of the random delay variable according to the value of Nₘₐₓ (which is labeled as 211) and delay its next uplink transmission according to the delay value (which is labeled as 213). For example, if the value of Nₘₐₓ received by a certain LPWAN terminal 15 is “10” (i.e., ten units of time), then the LPWAN terminal 15 may randomly generate a delay value (e.g., “3”) in the range of 0 to 10, and then delay its next uplink transmission according to the delay value (e.g., delay by 3 milliseconds if one unit of time is one millisecond).

In some embodiments, the LPWAN server 11 may also be configured to store the delay parameter 20 (i.e., Nₘₐₓ) calculated for each of the LPWAN terminals 15 as a group of historical upper limit reference values. Additionally, instead of calculating Nₘₐₓ according to the equation (1), the LPWAN server 11 may also calculate a specific delay parameter directly according to an average and a standard deviation of the group of historical upper limit reference values stored by the LPWAN server 11 (which is labeled as 205), and carry the specific delay parameter in the ACK message to be transmitted to the LPWAN terminal 15. After receiving the specific delay parameter, the LPWAN terminal 15 may randomly generate a delay value according to the value of the specific delay parameter (which is labeled as 211), and delay its next uplink transmission according to the delay value (which is labeled as 213).

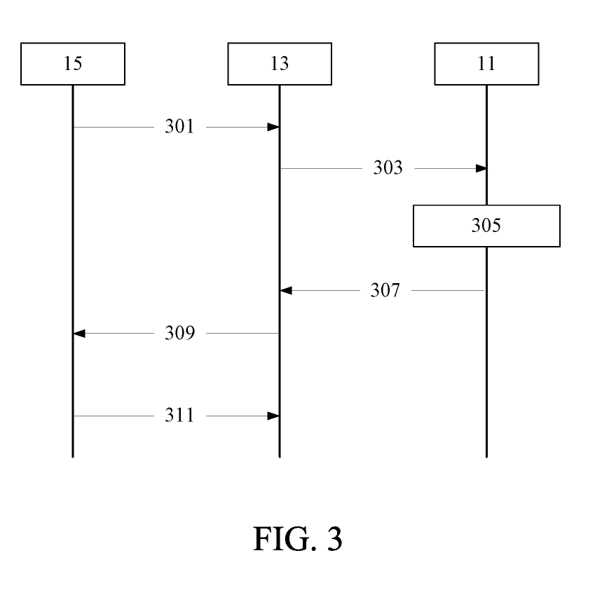

FIG. 3 illustrates another operating mode of the LPWAN system shown in FIG. 1 in one or more embodiments of the present invention. However, contents shown in FIG. 3 are only for purpose of illustrating embodiments of the present invention instead of limiting the present invention.

Like FIG. 2, FIG. 3 shows that any uplink transmission process may comprise four basic procedures respectively of: transmitting data to the LPWAN gateway 13 by the LPWAN terminal 15 (which is labeled as 301); transmitting data to the LPWAN server 11 by the LPWAN gateway 13 (which is labeled as 303); transmitting an acknowledgment (ACK) message to the LPWAN gateway 13 by the LPWAN server 11 after receiving the data (which is labeled as 307); and transmitting the acknowledgement message (the ACK or NACK message) to the LPWAN terminal 15 by the LPWAN gateway 13 (which is labeled as 309).

Unlike FIG. 2, FIG. 3 shows that a delay parameter 20 defined by the LPWAN server 11 for each LPWAN terminal 15 is a delay value in a range of a random delay variable instead of an upper limit reference value of the range. In detail, in FIG. 3, the LPWAN server 11 also first calculates the value of Nₘₐₓ based on the equation (1), then further randomly generates a delay value by taking the value of Nₘₐₓ as an upper limit reference value of a random variable (which is labeled as 305), and carry the delay value in the ACK message transmitted to the LPWAN gateway 13. After receiving the corresponding delay value, each of the LPWAN terminals 15 may delay its next uplink transmission according to the delay value (which is labeled as 311). For example, if the delay value received by a certain LPWAN terminal 15 is “5” (i.e., five units of time), then the LPWAN terminal 15 delays its next uplink transmission (e.g., by 5 milliseconds if one unit of time is one millisecond).

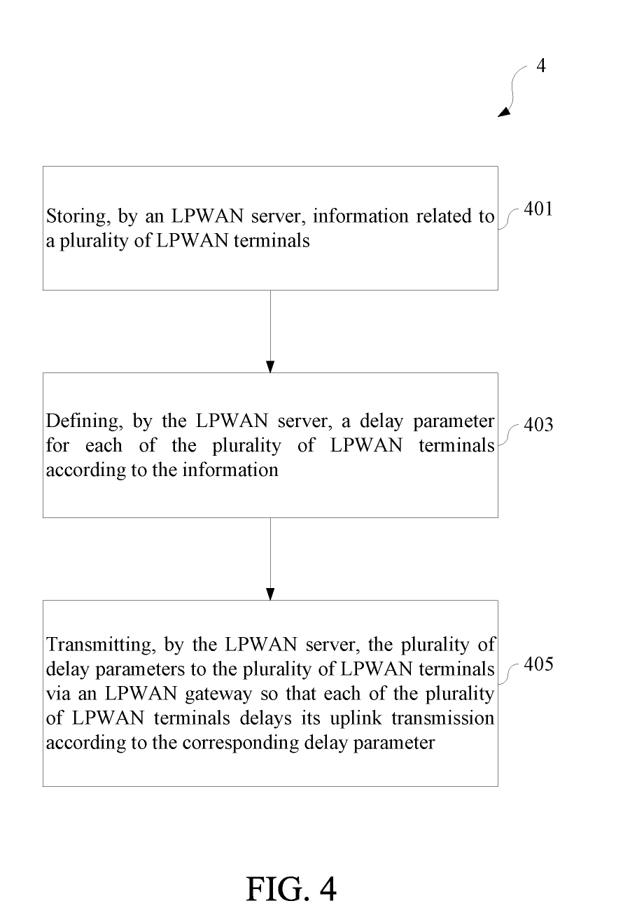

FIG. 4 illustrates a method of avoiding uplink transmission collision in one or more embodiments of the present invention. However, contents shown in FIG. 4 are only for purpose of illustrating embodiments of the present invention instead of limiting the present invention.

Referring to FIG. 4, a method 4 of avoiding uplink transmission collision may comprise the following steps of:

storing, by an LPWAN server, information related to a plurality of LPWAN terminals (labeled as 401);

defining, by the LPWAN server, a delay parameter for each of the plurality of LPWAN terminals according to the information (labeled as 403); and

transmitting, by the LPWAN server, the plurality of delay parameters to the plurality of LPWAN terminals via an LPWAN gateway so that each of the plurality of LPWAN terminals delays its uplink transmission according to the corresponding delay parameter (labeled as 405).

In some embodiments, for the method 4, each of the plurality of delay parameters may be an upper limit reference value of a range of a random delay variable, and each of the plurality of LPWAN terminals may randomly generate a delay value in the range of the random delay variable according to the corresponding delay parameter and delay its uplink transmission according to the corresponding delay value.

In some embodiments, for the method 4, each of the plurality of delay parameters may be an upper limit reference value of a range of a random delay variable, and each of the plurality of LPWAN terminals may randomly generate a delay value in the range of the random delay variable according to the corresponding delay parameter and delay its uplink transmission according to the corresponding delay value. Additionally, the method 4 may further comprise the following step of:

storing, by the LPWAN server, a group of historical upper limit reference values defined by the LPWAN server for each of the plurality of LPWAN terminals;

for each of the plurality of LPWAN terminals, calculating, by the LPWAN server, a specific delay parameter according to an average and a standard deviation of the corresponding group of historical upper limit reference values; and transmitting, by the LPWAN server, the plurality of specific delay parameters to the plurality of LPWAN terminals via the LPWAN gateway so that each of the plurality of LPWAN terminals delays its uplink transmission according to the corresponding specific delay parameter.

In some embodiments, for the method 4, each of the plurality of delay parameters may be a delay value in a range of a random delay variable, and each of the plurality of LPWAN terminals may delay its uplink transmission according to the corresponding delay value.

In some embodiments, for the method 4, the information related to the plurality of LPWAN terminals may comprise a received signal strength indicator related to each of the plurality of LPWAN terminals, and the method 4 may further comprise the following step: obtaining, by the LPWAN server, the plurality of received signal strength indicators from the LPWAN gateway.

In some embodiments, for the method 4, the information related to the plurality of LPWAN terminals comprises a received signal strength indicator related to each of the plurality of LPWAN terminals and at least one of: an application type of each of the plurality of LPWAN terminals, the number of re-transmissions of each of the plurality of LPWAN terminals, a density of the plurality of LPWAN terminals, and a transmission type of each of the plurality of LPWAN terminals. Additionally, the method 4 may further comprise the following step of: obtaining, by the LPWAN server, the plurality of received signal strength indicators from the LPWAN gateway.

In some embodiments, the method 4 may be implemented under the LPWAN system 1. All corresponding steps for implementing the method 4 under the LPWAN system 1 shall be readily appreciated by a person having ordinary skill in the art depending on the above descriptions of the LPWAN system 1, and thus will not be further described herein.

One or more embodiments of the present invention may further comprise a method of avoiding uplink transmission collision. The method may comprise the following steps of:

receiving via an LPWAN gateway, by an LPWAN terminal, a delay parameter transmitted by an LPWAN server; and

delaying, by the LPWAN terminal, its uplink transmission according to the delay parameter.

For the method, the delay parameter may be an upper limit reference value of a range of a random delay variable, and the LPWAN terminal may randomly generate a delay value in the range of the random delay variable according to the delay parameter and delay its uplink transmission according to the delay value.

For the method, the delay parameter may be a delay value in a range of a random delay variable, and the LPWAN terminal may delay its uplink transmission according to the delay value.

In some embodiments, the method may be implemented under the LPWAN system 1. All corresponding steps for implementing the method under the LPWAN system 1 shall be readily appreciated by a person having ordinary skill in the art depending on the above descriptions of the LPWAN system 1, and thus will not be further described herein.

According to the above descriptions, in the embodiments of the present invention, an LPWAN server may properly define a delay parameter for each of a plurality of LPWAN terminals according to various information related to the plurality of LPWAN terminals (e.g., a received signal strength indicator related to each of the plurality of LPWAN terminals, an application type of each of the plurality of LPWAN terminals, a number of re-transmissions of each of the plurality of LPWAN terminals, a density of the plurality of LPWAN terminals, and/or a transmission type of each of the plurality of LPWAN terminals), and each of the LPWAN terminals can delay its uplink transmission according to the corresponding delay parameter. Accordingly, time points at which the plurality of LPWAN terminals initiate the uplink transmission thereof can be staggered so as to avoid collision of all or a part of uplink transmissions of the plurality of LPWAN terminals (no matter on the LPWAN gateway or on the LPWAN server).

The above disclosure is related to the detailed technical contents and inventive features thereof. A person having ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A low-power wide-area network (LPWAN) server, comprising:
a storage, being configured to store information related to a plurality of LPWAN terminals;
a processor electrically connected with the storage, being configured to define a delay parameter for each of the plurality of LPWAN terminals according to the information; and
a transceiver electrically connected with the processor, being configured to transmit the plurality of delay parameters to the plurality of LPWAN terminals via an LPWAN gateway so that each of the plurality of LPWAN terminals delays its uplink transmission according to the corresponding delay parameter.

2. The LPWAN server of claim 1, wherein each of the plurality of delay parameters is an upper limit reference value of a range of a random delay variable, and each of the plurality of LPWAN terminals randomly generates a delay value in the range of the random delay variable according to the corresponding delay parameter and delays its uplink transmission according to the corresponding delay value.

3. The LPWAN server of claim 2, wherein:
the storage is further configured to store a group of historical upper limit reference values defined by the processor for each of the plurality of LPWAN terminals;
for each of the plurality of LPWAN terminals, the processor is further configured to calculate a specific delay parameter according to an average and a standard deviation of the corresponding group of historical upper limit reference values; and
the transceiver is further configured to transmit the plurality of specific delay parameters to the plurality of LPWAN terminals via the LPWAN gateway so that each of the plurality of LPWAN terminals delays its uplink transmission according to the corresponding specific delay parameter.

4. The LPWAN server of claim 1, wherein each of the plurality of delay parameters is a delay value in a range of a random delay variable, and each of the plurality of LPWAN terminals delays its uplink transmission according to the corresponding delay value.

5. The LPWAN server of claim 1, wherein:
the information related to the plurality of LPWAN terminals comprises a received signal strength indicator related to each of the plurality of LPWAN terminals; and
the transceiver is further configured to obtain the plurality of received signal strength indicators from the LPWAN gateway.

6. The LPWAN server of claim 5, wherein the information related to the plurality of LPWAN terminals also comprises at least one of: an application type of each of the plurality of LPWAN terminals, the number of re-transmissions of each of the plurality of LPWAN terminals, a density of the plurality of LPWAN terminals, and a transmission type of each of the plurality of LPWAN terminals.

7. A method of avoiding uplink transmission collision, comprising:
storing, by an LPWAN server, information related to a plurality of LPWAN terminals;
defining, by the LPWAN server, a delay parameter for each of the plurality of LPWAN terminals according to the information; and
transmitting, by the LPWAN server, the plurality of delay parameters to the plurality of LPWAN terminals via an LPWAN gateway so that each of the plurality of LPWAN terminals delays its uplink transmission according to the corresponding delay parameter.

8. The method of claim 7, wherein each of the plurality of delay parameters is an upper limit reference value of a range of a random delay variable, and each of the plurality of LPWAN terminals randomly generates a delay value in the range of the random delay variable according to the corresponding delay parameter and delays its uplink transmission according to the corresponding delay value.

9. The method of claim 8, further comprising:
storing, by the LPWAN server, a group of historical upper limit reference values defined by the LPWAN server for each of the plurality of LPWAN terminals;
for each of the plurality of LPWAN terminals, calculating, by the LPWAN server, a specific delay parameter according to an average and a standard deviation of the corresponding group of historical upper limit reference values; and
transmitting, by the LPWAN server, the plurality of specific delay parameters to the plurality of LPWAN terminals via the LPWAN gateway so that each of the plurality of LPWAN terminals delays its uplink transmission according to the corresponding specific delay parameter.

10. The method of claim 7, wherein each of the plurality of delay parameters is a delay value in a range of a random delay variable, and each of the plurality of LPWAN terminals delays its uplink transmission according to the corresponding delay value.

11. The method of claim 7, wherein the information related to the plurality of LPWAN terminals comprises a received signal strength indicator related to each of the plurality of LPWAN terminals, and the method further comprises the following step: obtaining, by the LPWAN server, the plurality of received signal strength indicators from the LPWAN gateway.

12. The method of claim 11, wherein the information related to the plurality of LPWAN terminals also comprises at least one of: an application type of each of the plurality of LPWAN terminals, the number of re-transmissions of each of the plurality of LPWAN terminals, a density of the plurality of LPWAN terminals, and a transmission type of each of the plurality of LPWAN terminals.

13. A low-power wide-area network terminal, comprising:
a transceiver, being configured to receive a delay parameter transmitted by an LPWAN server via an LPWAN gateway; and
a processor electrically connected with the transceiver, being configured to instruct the transceiver to delay an uplink transmission of the LPWAN terminal according to the delay parameter.

14. The LPWAN terminal of claim 13, wherein the delay parameter is an upper limit reference value of a range of a random delay variable, and the processor randomly generates a delay value in the range of the random delay variable according to the delay parameter and delays the uplink transmission according to the delay value.

15. The LPWAN terminal of claim 13, wherein the delay parameter is a delay value in a range of a random delay variable, and the processor delays the uplink transmission according to the delay value.
